(19) United States
(12) Patent Application Publication
(10) Pub. No.: US 2020/0298840 A1
(43) Pub. Date: Sep. 24, 2020

(54) VEHICLE INFORMATION PROCESSING APPARATUS AND VEHICLE INFORMATION PROCESSING METHOD

(71) Applicant: Mitsubishi Electric Corporation, Tokyo (JP)

(72) Inventors: Mitsuo SHIMOTANI, Tokyo (JP); Naoki ISOZAKI, Tokyo (JP); Hirokazu CHIYONOBU, Tokyo (JP); Yuji IGARASHI, Tokyo (JP)

(73) Assignee: Mitsubishi Electric Corporation, Tokyo (JP)

(21) Appl. No.: 16/763,462

(22) PCT Filed: Jan. 26, 2018
(86) PCT No.: PCT/JP2018/002554

§ 371 Date: May 12, 2020

(51) Int. Cl. B60W 30/08; G08G 1/01; G07C 5/00

(52) U.S. Cl. CPC B60W 30/08; G08G 1/0125; B60W 2556/65; G07C 5/008; B60W 2554/4049; G08G 1/0112

(57) ABSTRACT

It is an object to provide a technique capable of optimizing a caution degree which is a degree of caution to be exerted in a vehicle. A controller determines whether a mutual dangerous driving has been performed based on travel information of a plurality of vehicles acquired in an acquisition part, and obtaining a caution degree which is a degree of caution to be exerted in each of the plurality of vehicles based on a determination result. The controller performs control of correcting a caution degree of a first vehicle in the plurality of vehicles based on a caution degree of a second vehicle in the plurality of vehicles which has performed the mutual dangerous driving with the first vehicle.

### TECHNICAL FIELD

The present invention relates to a vehicle information processing apparatus and a vehicle information processing method.

### BACKGROUND ART

Known is a probe system collecting sensor information acquired by a vehicle traveling along a road in a center server and analyzing road information or traffic information. For example, Patent Document 1 describes a technique of collecting information of occurrence position where a dangerous driving (wild driving) such as a sudden braking has occurred in a server and performing statistical processing on the information, thereby determining an area where the dangerous driving is common.

The occurrence of the dangerous driving is caused by a structure and a shape of a road in many cases, but is also caused by a driving tendency of a dangerous driver such as a beginner driver and a wild driver. Accordingly, proposed is a technique of, when a vehicle performs a dangerous driving such as a sudden braking, uploading information of the dangerous driving to a center server and performing statistic processing, and determining a caution-needed vehicle driven by the dangerous driver, thereby attracting attention to the caution-needed vehicle.

### PRIOR ART DOCUMENTS

### Patent Documents

Patent Document 1: Japanese Patent Application Laid-Open No. 2015-75791

### SUMMARY

### Problem to be Solved by the Invention

However, there is a case where a normal vehicle driven by a normal driver which has encountered the caution-needed vehicle is forced to perform an unwilling dangerous driving to immediately respond to the dangerous driving of the caution-needed vehicle and perform an emergency detour. There is also a case where the normal vehicle unfortunately encounters the caution-needed vehicle a number of times, thereby being forced to repeat the dangerous driving. Regardless of such a case, the technique described above simply determines the vehicle which has performed the dangerous driving a number of times to be the caution-needed vehicle, thus has a problem that it determines the normal vehicle to be the caution-needed vehicle.

The present invention therefore has been made to solve the above problems, and it is an object to provide a technique capable of optimizing a caution degree which is a degree of caution to be exerted in a vehicle.

### Means to Solve the Problem

A vehicle information processing apparatus according to the present invention includes: an acquisition part acquiring travel information of a plurality of vehicles; and a control part determining whether a mutual dangerous driving which is a dangerous driving mutually related between two or more vehicles in the plurality of vehicles has been performed based on the travel information of the plurality of vehicles acquired in the acquisition part, and obtaining a caution degree which is a degree of caution to be exerted in each of the plurality of vehicles based on a determination result, wherein the controller performs control of correcting the caution degree of a first vehicle in the plurality of vehicles based on the caution degree of a second vehicle in the plurality of vehicles which has performed the mutual dangerous driving with the first vehicle.

### Effects of the Invention

According to the present invention, the caution degree of the first vehicle in the plurality of vehicles is corrected based on the caution degree of the second vehicle in the plurality of vehicles which has performed the mutual dangerous driving with the first vehicle. Accordingly, optimization of the caution degree which is the degree of caution to be exerted in a vehicle can be achieved.

These and other objects, features, aspects and advantages of the technique disclosed in the present invention will become more apparent from the following detailed description of the specification of the present application when taken in conjunction with the accompanying drawings.

### BRIEF DESCRIPTION OF DRAWINGS

FIG. 1 A block diagram illustrating a configuration of a vehicle information processing device according to an embodiment 1.

FIG. 2 A drawing for explaining an operation example of a controller.

FIG. 3 A drawing for explaining an operation example of the controller.

FIG. 4 A drawing for explaining an operation example of the controller.

FIG. 5 A block diagram illustrating a configuration of a vehicle information processing device according to an embodiment 2.

FIG. 6 A flow chart illustrating an operation of the vehicle information processing device according to the embodiment 2.

FIG. 7 A drawing for explaining an operation example of the vehicle information processing device according to the embodiment 2.

FIG. 8 A drawing for explaining an operation example of the vehicle information processing device according to the embodiment 2.

FIG. 9 A drawing for explaining an operation example of the vehicle information processing device according to the embodiment 2.

FIG. 10 A drawing for explaining an operation example of the vehicle information processing device according to the embodiment 2.

FIG. 11 A drawing for explaining an operation example of the vehicle information processing device according to the embodiment 2.

FIG. 12 A block diagram illustrating a configuration of a vehicle information processing device according to an embodiment 3.

FIG. 13 A drawing illustrating a display example according to a modification example 1 of the embodiment 3.

FIG. 14 A drawing illustrating a display example according to a modification example 1 of the embodiment 3.

FIG. 15 A flow chart illustrating an operation of a vehicle information processing device according to the embodiment 4.

FIG. 16 A block diagram illustrating a configuration of a vehicle information processing device according to an embodiment 5.

FIG. 17 A block diagram illustrating a hardware configuration of a navigation device according to another modification example.

FIG. 18 A block diagram illustrating a hardware configuration of a navigation device according to another modification example.

### DESCRIPTION OF EMBODIMENT(S)

### Embodiment 1

FIG. 1 is a block diagram illustrating a configuration of a vehicle information processing device according to an embodiment 1 of the present invention. A vehicle information processing device 1 in FIG. 1 is a device included in a center server which can communicate with a probe vehicle provided with a communication device, for example, and includes an acquisition part 11 and a controller 12.

The acquisition part 11 performs a wireless communication with a plurality of probe vehicles, thereby acquiring travel information of the plurality of probe vehicles from the plurality of probe vehicles. The acquisition part 11 is a communication device and an interface of the communication device, for example.

The controller 12 determines whether a mutual dangerous driving which is a dangerous driving mutually associated between the two or more probe vehicles in the plurality of probe vehicles has been performed based on the travel information of the plurality of probe vehicles acquired in the acquisition part 11.

The travel information acquired in the acquisition part 11 needs to be information enabling a determination of the mutual dangerous driving. Such travel information includes time-series information regarding a traveling of the plurality of probe vehicles and a determination result of the mutual dangerous driving in the probe vehicle, for example.

The controller 12 acquires a caution degree which is a degree of caution to be exerted in each of the plurality of probe vehicles based on the determination result whether the mutual dangerous driving has been performed. The caution degree can also be referred to as a wild driving score.

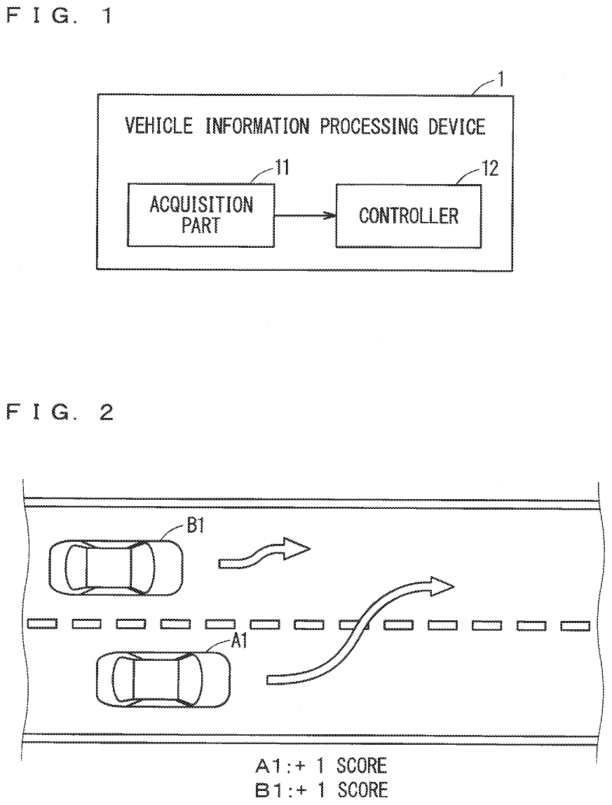

FIG. 2 to FIG. 4 are drawings each for explaining the determination of the mutual dangerous driving and a calculation of the caution degree in the controller 12.

In the example in FIG. 2 to FIG. 4, the controller 12 determines that the probe vehicle has performed the dangerous driving when the controller 12 determines that a change of a traveling direction of the probe vehicle is equal to or larger than a threshold value or determines that a deceleration degree of the probe vehicle is equal to or larger than a threshold value based on the travel information of the probe vehicle. Then, the controller 12 determines that the two probe vehicles have performed the mutual dangerous driving when the controller 12 determines that a distance between the two probe vehicles is equal to or smaller than a threshold value and determines that each of the two probe vehicles has performed the dangerous driving, and increases the caution degree of the two probe vehicles by one score for each vehicle.

The example in FIG. 2 illustrates a caution-needed vehicle A1 which is a probe vehicle driven by a dangerous driver such as a beginner driver and a wild driver and a normal vehicle B1 driven by a normal driver other than the dangerous driver. Specifically, it illustrates that a change of a traveling direction of the caution-needed vehicle A1 is equal to or larger than a threshold value by reason that the caution-needed vehicle A1 has suddenly changed lane, and a deceleration degree of the normal vehicle B1 is equal to or larger than a threshold value by reason that the normal vehicle B1 has suddenly braked hard. The distance between the normal vehicle B1 and the caution-needed vehicle A1 is equal to or smaller than a threshold value. In this case, the controller 12 determines that the normal vehicle B1 and the caution-needed vehicle A1 have performed the mutual dangerous driving, and increases the caution degree of each of the normal vehicle B1 and the caution-needed vehicle A1 by one score for each vehicle.

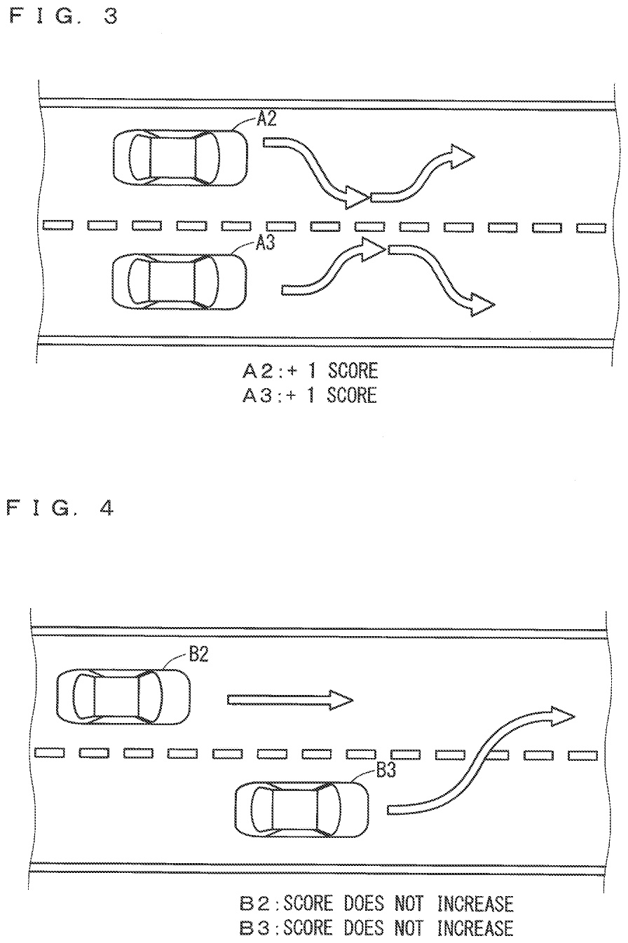

The example in FIG. 3 illustrates a case where a change of each traveling direction of the caution-needed vehicles A2 and A3 is equal to or larger than a threshold value by reason that the caution-needed vehicles A2 and A3 have suddenly changed lanes. The distance between the caution-needed vehicles A2 and A3 is equal to or smaller than a threshold value. In this case, the controller 12 determines that the caution-needed vehicles .A2 and A3 have performed the mutual dangerous driving, and increases the caution degree of each of the caution-needed vehicles A2 and A3 by one score for each vehicle.

The example in FIG. 4 illustrates a case where a change of a traveling direction of a normal vehicle B2 is smaller than a threshold value by reason that the normal vehicle B2 has gradually changed lane and a deceleration degree of a normal vehicle B3 is smaller than a threshold value by reason that the normal vehicle B3 has gradually braked. The distance between the normal vehicles B2 and B3 is equal to or smaller than a threshold value. In this case, the controller 12 does not determine that the normal vehicles B2 and B3 have performed the mutual dangerous driving and does not increase the caution degree of the normal vehicles B2 and B3.

If only the cases illustrated in FIG. 3 and FIG. 4 occur, the caution degree of the caution-needed vehicle and the normal vehicle is appropriate also in the operations described above, however, the case illustrated in FIG. 2 also occurs in a practical use. Accordingly, the caution degree of the normal vehicle tends to be inappropriate in the operation described above.

Thus, the controller 12 according to the present embodiment 1 performs control of correcting the caution degree of a first vehicle in the plurality of probe vehicles based on the caution degree of a second vehicle in the plurality of probe vehicles which has performed the mutual dangerous driving with the first vehicle.

As one example of the correction, the controller 12 may perform a correction of reducing the caution degree of the first vehicle when the caution degree of the second vehicle which has performed the mutual dangerous driving with the first vehicle is equal to or larger than a predetermined threshold value. As another example of the correction, the controller 12 may perform a correction of reducing the caution degree of the first vehicle based on the number of second vehicles, in the plurality of second vehicles which have performed the mutual dangerous driving with the first vehicle in a certain period of time (for example, one month and one year), each having latest caution degree equal to or larger than a threshold value.

### Conclusion of embodiment 1

The vehicle information processing device 1 according to the present embodiment 1 describe above performs the control of correcting the caution degree of the first vehicle based on the caution degree of the second vehicle which has performed the mutual dangerous driving with the first vehicle. According to such a configuration, the correction of reducing the caution degree of the vehicle which has performed the mutual dangerous driving with the caution-needed vehicle which has relatively the high caution degree can be performed, thus an optimization of the caution degree can be achieved.

### Embodiment 2

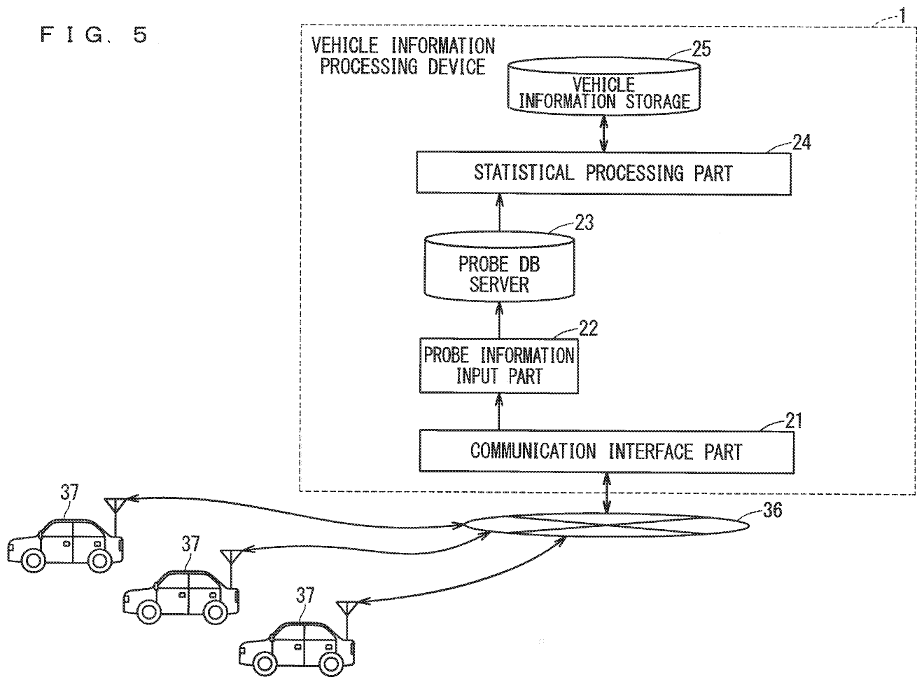

FIG. 5 is a block diagram illustrating a configuration of the vehicle information processing device 1 according to an embodiment 2 of the present invention. The same reference numerals as those described above will be assigned to the same or similar constituent element in the configuration according to the present embodiment 2, and the different constituent elements are mainly described hereinafter.

The vehicle information processing device 1 according to the present embodiment 2 is a device included in a center server, and can communicate with a plurality of probe vehicles 37 via a communication network 36 such as Internet.

In the present embodiment 2, a detection device such as a sensor and a camera is provided in the probe vehicle 37, and the probe vehicle 37 determines whether the mutual dangerous driving has been performed based on information detected in the detection device. This determination is similar to the determination described in the embodiment 1. The probe vehicle 37 transmits travel information including a determination result on the mutual dangerous driving to the vehicle information processing device 1.

The vehicle information processing device 1 is described next. The vehicle information processing device 1 in FIG. 5 includes a communication interface part 21, a probe information input part 22, a probe DB (database) server 23, a statistical processing part 24, and a vehicle information storage 25. The communication interface part 21 is included in a concept of the acquisition part 11 in FIG. 1 and the statistical processing part 24 is included in a concept of the controller 12 in FIG. 1.

The communication interface part 21 acquires (receives) the travel information including the determination result whether the mutual dangerous driving has been performed from the plurality of probe vehicles 37 via the communication network 36 such as Internet.

The probe information input part 22 stores the travel information acquired in the communication interface part 21 in the probe DB server 23.

The statistical processing part 24 determines whether the mutual dangerous driving has been performed based on the travel information stored in the probe DB server 23. In the present embodiment 2, the determination is performed in each probe vehicle 37, thus the statistical processing part 24 uses the determination result in the plurality of probe vehicles 37 as the determination result in the statistical processing part 24.

The statistical processing part 24 obtains the caution degree of each of the plurality of probe vehicles 37 based on the determination result. In the present embodiment 2, the statistical processing part 24 obtains the number of mutual dangerous drivings performed in the certain period of time as the caution degree.

The statistical processing part 24 performs control of correcting the caution degree of the first vehicle in the plurality of probe vehicles 37 based on the caution degree of the second vehicle in the plurality of probe vehicles 37 which has performed the mutual dangerous driving with the first vehicle. In the present embodiment 2, the statistical processing part 24 performs a correction of reducing the caution degree of the first vehicle based on the number of second vehicles, in the plurality of second vehicles which have performed the mutual dangerous driving with the first vehicle in a certain period of time, each having latest caution degree equal to or larger than a threshold value.

Specifically, the statistical processing part 24 temporarily classifies the plurality of probe vehicles 37 based on the caution degree of each of the plurality of probe vehicles 37. Herein, as an example thereof, the statistical processing part 24 temporarily classifies the probe vehicle 37 having the caution degree equal to or larger than the threshold value as the caution-needed vehicle, and classifies the probe vehicle 37 having the caution degree smaller than the threshold value as the normal vehicle. Then, the statistical processing part 24 corrects the caution degree of the first vehicle based on the number of probe vehicles classified as the caution-needed vehicle in the probe vehicles 37 which have performed the mutual dangerous driving with the first vehicle in a certain period of time. The statistical processing part 24 performs this correction on each of the plurality of probe vehicles 37. Subsequently, the statistical processing part 24 classifies the plurality of probe vehicles 37 based on the corrected caution degree of each of the plurality of probe vehicles 37 in the manner similar to the temporal classification described above.

The vehicle information storage 25 stores the corrected caution degree and the classification result indicating one of the caution-needed vehicle and the normal vehicle. The vehicle information storage 25 stores an in-center vehicle ID which enables the statistical processing part 24 to sort the plurality of probe vehicles 37.

<Operation>

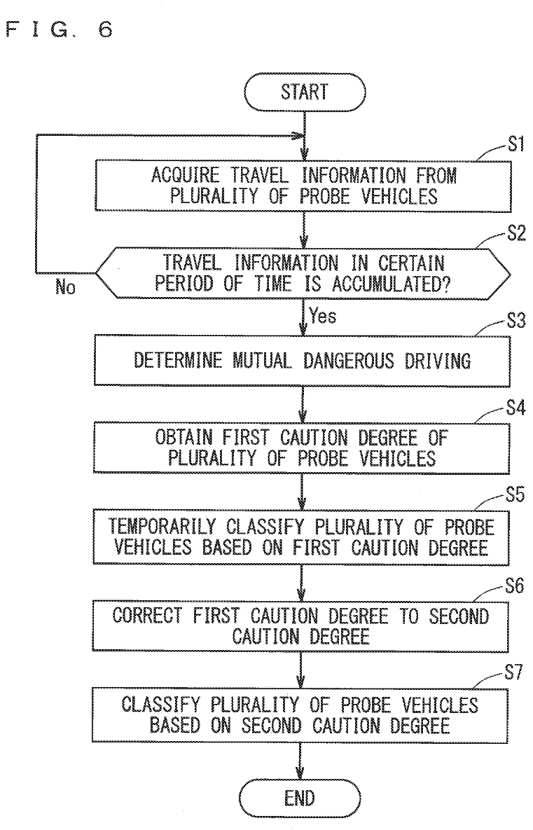

FIG. 6 is a flow chart illustrating an operation of the vehicle information processing device 1 according to the present embodiment 2.

In Step S1, the communication interface part 21 acquires the travel information from the plurality of probe vehicles 37, and the probe information input part 22 stores the acquired travel information in the probe DB server 23.

In Step S2, the statistical processing part 24 determines whether or not the travel information in a certain period of time such as one month and one year, for example, has been accumulated in the probe DB server 23. When the travel information is determined to be accumulated, the step proceeds to Step S3, and when the travel information is not determined to be accumulated, the step returns to Step S1.

In Step S3, the statistical processing part 24 determines whether the mutual dangerous driving has been performed based on the travel information of the plurality of probe vehicles 37 stored in the probe DB server 23.

In Step S4, the statistical processing part 24 obtains the caution degree of each of the plurality of probe vehicles 37 based on the determination result. In the description hereinafter, the caution degree obtained at this time is referred to as “the first caution degree” and the first caution degree corrected in Step S6 described hereinafter is referred to as “the second caution degree” in some cases.

In Step S5, the statistical processing part 24 temporarily classifies each of the plurality of probe vehicles 37 as one of the caution-needed vehicle and the normal vehicle based on the first caution degree.

In Step S6, the statistical processing part 24 corrects the first caution degree of the first vehicle to the second caution degree based on the number of probe vehicles temporarily classified as the caution-needed vehicle in the probe vehicles 37 which have performed the mutual dangerous driving with the first vehicle in a certain period of time.

In Step S7, the statistical processing part 24 classifies each of the plurality of probe vehicles 37 as one of the caution-needed vehicle and the normal vehicle based on the second caution degree. Subsequently, the operation in FIG. 6 is finished. After the operation in FIG. 6 is finished, the operation in FIG. 6 is appropriately started to update the travel information, for example.

<Operation Example>

Described hereinafter is an operation example of the vehicle information processing device 1 according to the present embodiment 2. In this operation example, it is assumed that, for simplifying the description, (A) the number of true caution-needed vehicles is 10000 and the number of true normal vehicles is 90000, (B) all the vehicles including the true caution-needed vehicles and the true normal vehicles encounter n times in a random combination at the same timing, (C) the true caution-needed vehicle and a vehicle encountering the true caution-needed vehicle always perform the mutual dangerous driving, and (D) when a vehicle performs the dangerous driving, the first caution degree of the vehicle increases by one score. In this case, a probability P_{n, k} that an optional vehicle encounters the true caution-needed vehicle k times in a case where the number of encounters is n is expressed as the following equation (1) in accordance with a binomial distribution.

P_{n, k}=ₙCₖ·p^{k}·(1−p)^{n-k} (1)

Herein, ₙCₖ is a binomial coefficient. p indicates a probability that a certain vehicle encounters the true caution-needed vehicle each time, and p= 1/10 is satisfied herein.

<Step S4 in Operation Example>

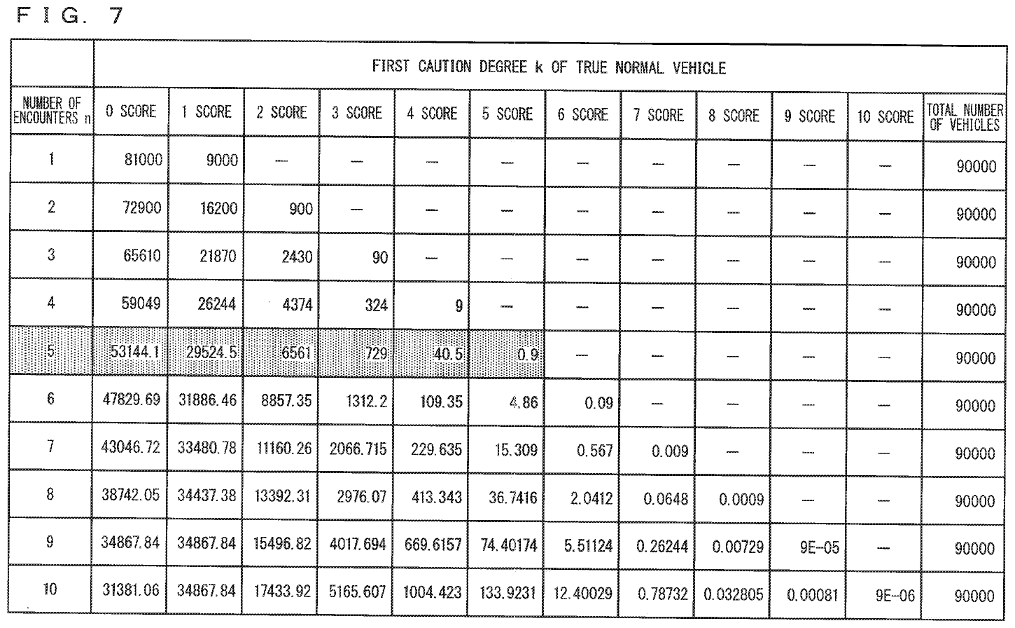

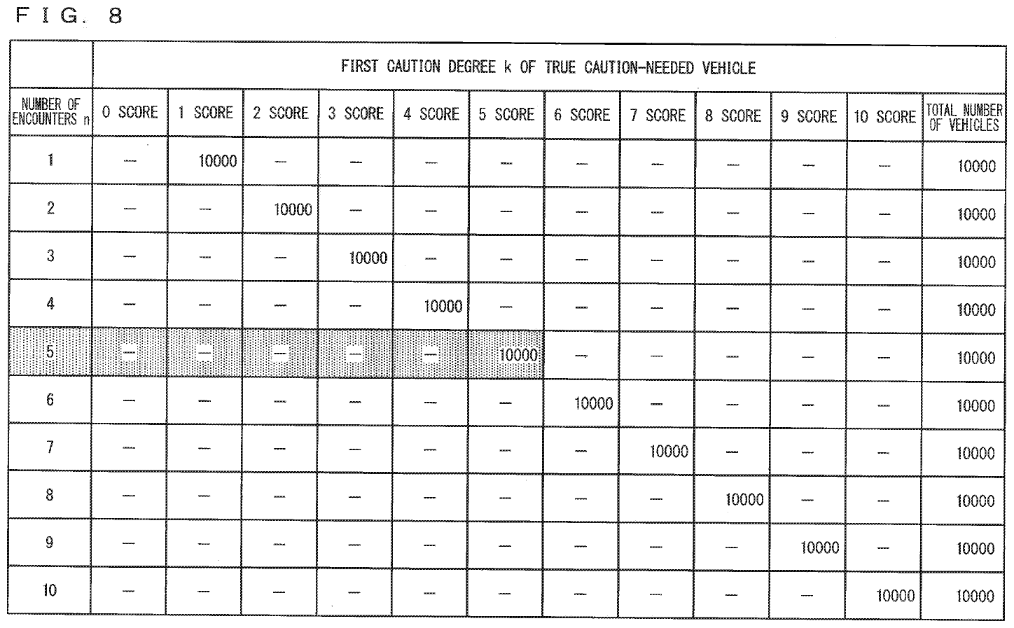

FIG. 7 and FIG. 8 are drawings each indicating a result of the first caution degree obtained in Step S4 in FIG. 6 when the above assumption is established.

FIG. 7 illustrates a distribution of the true normal vehicle which has encountered the true caution-needed vehicle k times, that is to say, a distribution of the true normal vehicle having the first caution degree of k score in a case where the number of encounters is n. This distribution is obtained based on the probability P_{n, k}. For example, a probability P_{1, 1} is 1/10, thus the number of true normal vehicles which have encountered the true caution-needed vehicle once and have the first caution degree of one score (k=1) in a first encounter (n=1) is 90000×( 1/10)=9000. For example, a probability P_{1, 0} is 9/10, thus the number of true normal vehicles which have encountered the true caution-needed vehicle zero time and have the first caution degree of zero score (k=0) in a first encounter (n=1) is 90000×( 9/10)=81000. The other number is also obtained based on the probability P_{n, k} in the similar manner.

Herein, as illustrated in FIG. 7, in the fifth encounter (n=5), the number of true normal vehicles having the first caution degree of five score (k=5) is 0.9, the number of true normal vehicles having the first caution degree of four score (k=4) is 40.5, and the number of true normal vehicles having the first caution degree of three score (k=3) is 729.

FIG. 8 illustrates a distribution of the true caution-needed vehicle which has encountered the true caution-needed vehicle k times, that is to say, a distribution of the true caution-needed vehicle having the first caution degree of k score in a case where the number of encounters is n. The true caution-needed vehicle always performs the dangerous driving regardless of whether or not a vehicle which the true caution-needed vehicle has encountered is the true caution-needed vehicle, thus the first caution degree and the number of encounters are equal to each other. Herein, in the fifth encounter (n=5), the number of true caution-needed vehicles having the first caution degree of five score (k=5) is 10000, which is the same as the total number of true the caution-needed vehicles.

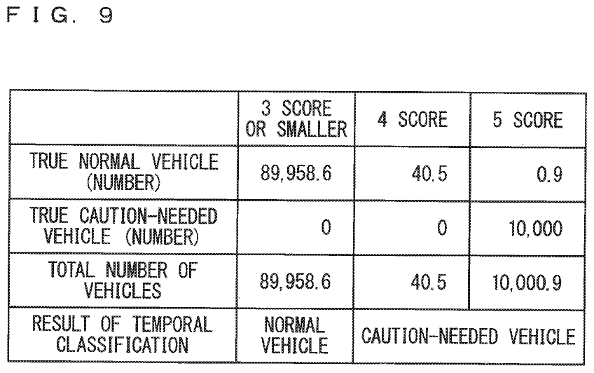

FIG. 9 is a drawing summarizing the results of first caution degree in FIG. 7 and FIG. 8 on the fifth encounter (n=5).

<Step S5 in Operation Example>

In Step S5 in FIG. 6, the statistical processing part 24 performs the temporal classification based on the result in FIG. 9. Assumed herein is a case where the statistical processing part 24 temporarily classifies the probe vehicle 37 having the first caution degree of four score or larger as the caution-needed vehicle and temporarily classifies the probe vehicle 37 having the first caution degree smaller than four score as the normal vehicle. In this case, 10041.4 vehicles in total which is a sum of the 40.5 true normal vehicles having the first caution degree of four score, the 0.9 true normal vehicles having the first caution degree of five score, and the 10000 true caution-needed vehicles having the first caution degree of five score in FIG. 9 are temporarily classified as the caution-needed vehicles. Then, the 89958.6 true normal vehicles having the first caution degree of three score or smaller in FIG. 9 are temporarily classified as the normal vehicles.

<Step S6 in Operation Example>

In Step S6 in FIG. 6, the statistical processing part 24 performs the following processing on the first vehicle in the plurality of probe vehicles 37: (i) when the number of probe vehicles which have been temporarily classified as the caution-needed vehicle in the probe vehicles 37 which have performed the mutual dangerous driving with the first vehicle in a certain period of time is five, correcting and reducing the first caution degree of the first vehicle by two score to obtain the second caution degree; and (ii) when the number of probe vehicles which have been temporarily classified as the caution-needed vehicle in the probe vehicles 37 which have performed the mutual dangerous driving with the first vehicle in a certain period of time is four, correcting and reducing the first caution degree of the first vehicle by one score to obtain the second caution degree.

In this case, the correction of (i) is applied to the 0.9 true normal vehicles having the first caution degree of five score in FIG. 9, thus the second caution degree of the 0.9 true normal vehicles is calculated to be three score (=five score—two score). The correction of (ii) is applied to the 40.5 true normal vehicles having the first caution degree of four score in FIG. 9, thus the second caution degree of the 40.5 true normal vehicles is calculated to be three score (=four score−one score).

The correction described above is applied when the first vehicle is the true normal vehicle. In the present operation example, both the true normal vehicle and the true caution-needed vehicle are applied to the first vehicle for simplifying the processing, thus the statistical processing part 24 performs the correction of (i) and (ii) also when the first vehicle is the true caution-needed vehicle. Herein, a probability that the true caution-needed vehicle encounters the true caution-needed vehicle k times in a case where the number of encounters is n is expressed as P_{n, k} of the equation (1) described above.

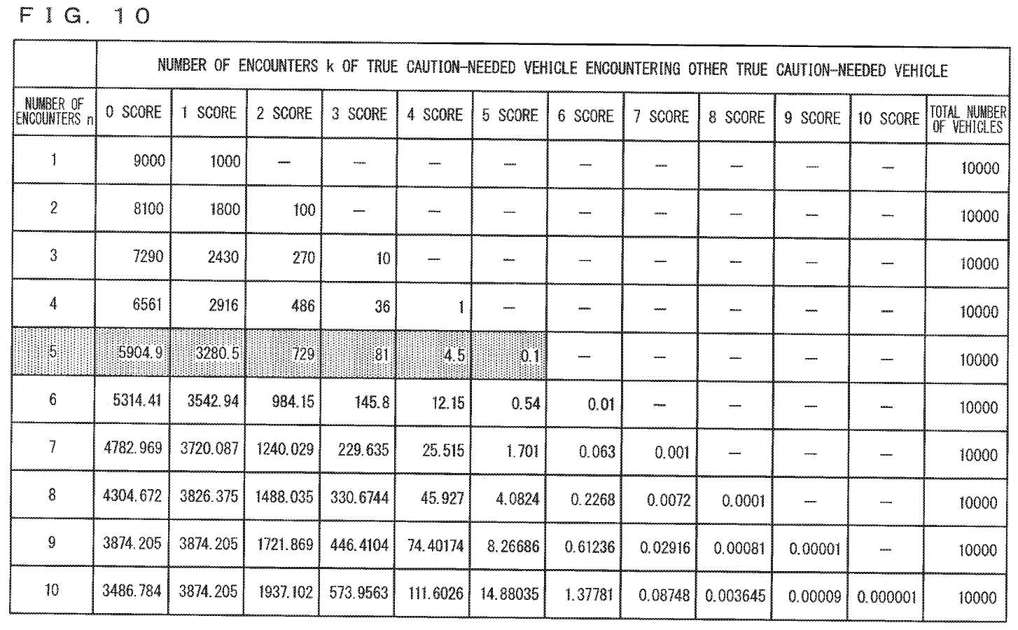

FIG. 10 illustrates a distribution of the true caution-needed vehicle indicating the number (number of times) of true caution-needed vehicles which have encountered the true caution-needed vehicle is k in a case where the number of encounters is n. For example, a probability P_{1, 1} is 1/10, thus the number of true caution-needed vehicles which have encountered the true caution-needed vehicle once (k 32 1) in a first encounter (n=1) is 10000×( 1/10)=1000. For example, a probability P_{1, 0} is 9/10, thus the number of true caution-needed vehicles which have encountered the true caution-needed vehicle zero time (k=0) in a first encounter (n=1) is 10000×( 9/10)=9000. The other number is also obtained based on the probability P_{n, k} in the similar manner.

Herein, as illustrated in FIG. 10, in the fifth encounter (n=5), the number of true caution-needed vehicles which have encountered the true caution-needed vehicle five times is 0.1, and the number of true caution-needed vehicles which have encountered the true caution-needed vehicles four times is 4.5. When the result in FIG. 10 and the result in FIG. 8 are correlated, it is recognized that the number of true caution-needed vehicles which have encountered the true caution-needed vehicles five times in the 10000 true caution-needed vehicles each having the first caution degree of five scores in FIG. 8 is 0.1, and the number of true caution-needed vehicles which have encountered the true caution-needed vehicles four times is 4.5.

In this case, the correction of (i) is applied to the 0.1 true caution-needed vehicles having the first caution degree of five score, thus the second caution degree of the 0.1 true caution-needed vehicles is calculated to be three score (=five score−two score). The correction of (ii) is applied to the 4.5 true caution-needed vehicles having the first caution degree of five score, thus the second caution degree of the 4.5 true caution-needed vehicles is calculated to be four score (=five score−one score).

The correction of the true caution-needed vehicle should be reflected in the correction of the second caution degree of the true normal vehicle and the correction of the second caution degree of the true normal vehicle should be reflected in the correction of the second caution degree of the true caution-needed vehicle to obtain the second caution degree more accurately. However, an influence thereof is negligibly small, thus the influence is ignored from a viewpoint of simplifying the correction processing in the present embodiment 2.

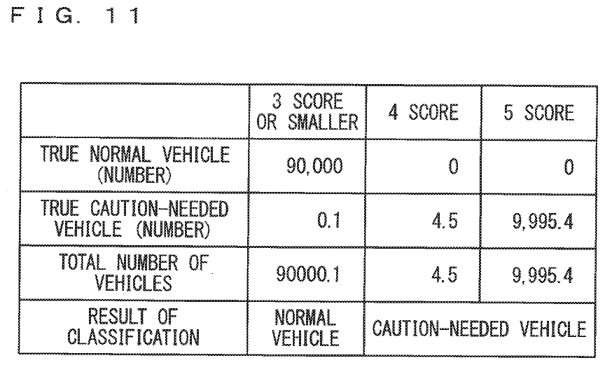

FIG. 11 is a drawing summarizing the result of second caution degree on the fifth encounter (n=5).

<Step S7 in Operation Example>

In Step S7 in FIG. 6, the statistical processing part 24 performs the classification based on the result in FIG. 11. Assumed herein is a case where the statistical processing part 24 classifies the probe vehicle 37 having the second caution degree of four score or more as the caution-needed vehicle and classifies the probe vehicle 37 having the second caution degree smaller than four score as the normal vehicle in the manner similar to Step S5. In this case, the 90000 true normal vehicles having the second caution degree of three score and the 0.1 true caution-needed vehicles having the second caution degree of three score are classified as the normal vehicles in FIG. 11. Then, the 9999.9 vehicles in total which is a sum of the 4.5 true caution-needed vehicles having the second caution degree of four score and the 9995.4 true caution-needed vehicles having the second caution degree of five score are classified as the caution-needed vehicles in FIG. 11. As a result, a probability that the true normal vehicle is erroneously recognized as the caution-needed vehicle is calculated to be 0%, and a probability that the true caution-needed vehicle is erroneously recognized as the normal vehicle is calculated to be 0.0001%. The probability of the erroneous recognition of 0.0001% is smaller than the probability of the erroneous recognition of 0.0414% obtained in the temporal classification in Step S5.

Herein, in a practical use, a frequency of the dangerous driving performed by the true caution-needed vehicle is considered to be higher than that performed by the true normal vehicle, thus the first and second caution degrees of the true caution-needed vehicle are considered to be high at comparatively an early time. The number of true normal vehicles is considered to be larger than that of the true caution-needed vehicles, thus the first and second caution degrees of the true caution-needed vehicle is considered to be high at comparatively an early time also from a viewpoint that the correction processing in Step S6 in FIG. 6 is hardly performed on the true caution-needed vehicle.

Herein, the operation example described above is based on the assumption that (B) all the vehicles including the true caution-needed vehicles and the true normal vehicles encounter n times in a random combination at the same timing. This assumption is hardly established in a practical use, however, the first and second caution degrees of the true caution-needed vehicle tend to be high at comparatively an early time as described above. Accordingly, it is considered that the effect of reducing the probability of the erroneous recognition can be obtained more in the practical use than in the operation example in which the assumption of (B) is established.

### Conclusion of Embodiment 2

The vehicle information processing device 1 according to the present embodiment 2 described above performs the correction of reducing the first caution degree of the first vehicle when the first caution degree of any second vehicle is equal to or larger than the threshold value, thus can achieve the optimization of the second caution degree of the plurality of probe vehicles.

According to the present embodiment 2, the travel information of the plurality of probe vehicles includes the determination result, whether the mutual dangerous driving has been performed, determined in the plurality of probe vehicles. According to such a configuration, the processing load of the vehicle information processing device 1 can be reduced.

According to the present embodiment 2, the plurality of probe vehicles are classified based on the second caution degree of the plurality of probe vehicles. According to such a configuration, the determination accuracy whether the probe vehicle is the normal vehicle or the caution-needed vehicle can be increased.

### Modification Example 1 of Embodiment 2

In the embodiment 2, the first caution degree is the number of mutual dangerous drivings performed in the certain period of time, but is not limited thereto. For example, the first caution degree may be a value obtained by normalizing the number of the mutual dangerous drivings of the probe vehicle by a travel distance or a travel time of the probe vehicle in a certain period of time. The first caution degree in this case may be not an integral number.

### Modification Example 2 of Embodiment 2

In the embodiment 2, the travel information includes the determination result, whether the mutual dangerous driving has been performed, determined in the probe vehicle, however, the configuration is not limited thereto.

For example, when the detection device mounted on the probe vehicle is configured to detect time-series information regarding a traveling of the probe vehicle and positional information of the probe vehicle, the probe vehicle may transmit probe information including the time-series information and the positional information as the travel information. That is to say, the travel information of the plurality of probe vehicles may be probe information including the time-series information and the positional information.

The detection device is a timer and a global navigation satellite system (GLASS) receiving device, for example. The positional information is information for specifying a position on map information, and is a latitude and longitude, a node of a road link, and a distance from the node, for example. The time can also be detected in the vehicle information processing device 1, however, an influence of delay due to a communication network can be reduced when it is detected in the probe vehicle.

In the above configuration, it is also applicable that the plurality of probe vehicles do not determine the mutual dangerous driving but the statistical processing part 24 determines whether the mutual dangerous driving has been performed in the plurality of probe vehicles based on the time-series information and the positional information of the probe vehicle acquired in the communication interface part 21.

It is also applicable that the statistical processing part 24 performs weighting on a server determination result which is a determination result based on the time-series information and the positional information in the vehicle information processing device 1 and a local determination result which is a determination result in the plurality of probe vehicles to determine whether the plurality of probe vehicles have performed the mutual dangerous driving.

It is also applicable that the statistical processing part 24 performs the determination of the mutual dangerous driving based only on the local determination result after determining that the server determination result and the local determination result coincide with each other. According to such a configuration, the determination accuracy can be increased and the processing load of the vehicle information processing device 1 can be reduced.

### Modification Example 3 of Embodiment 2

In the embodiment 2, the statistical processing part 24 increases the first caution degree by one score when one mutual dangerous driving is performed, however, the configuration is not limited thereto. For example, the communication interface part 21 may acquire the time-series information regarding the traveling of the probe vehicle. Then, the statistical processing part 24 may obtain a degree of dangerous driving which gets large with increase in a change of an acceleration of the probe vehicle, for example, based on the time-series information of the plurality of probe vehicles acquired in the communication interface part 21.

Then, the statistical processing part 24 may obtain the first caution degree of the plurality of probe vehicles also in consideration of the degree of the obtained dangerous driving. For example, the statistical processing part 24 may increase the first caution degree with increase in a change of an acceleration, that is to say, increase in a degree of dangerous driving. For example, it is also applicable that the statistical processing part 24 adds a value with a decimal point larger than zero score and equal to or smaller than two score to the first caution degree to increase the first caution degree in analog form. According to such a configuration, the optimization of the first caution degree of the plurality of probe vehicles and furthermore, the optimization of the second caution degree can be achieved.

### Modification Example 4 of Embodiment 2

In the embodiment 2, the statistical processing part 24 temporarily classifies the plurality of probe vehicles as one of the two types (the caution-needed vehicle and the normal vehicle) based on the first caution degree of the plurality of probe vehicles, however, the configuration is not limited thereto. For example, it is also applicable that the statistical processing part 24 temporarily classifies the probe vehicle having the first caution degree of four score or larger as the caution-needed vehicle, temporarily classifies the probe vehicle having the first caution degree larger than two score and smaller than four score as a semi-caution-needed vehicle, and temporarily classifies the probe vehicle having the first caution degree of two score or smaller as the normal vehicle. That is to say, the statistical processing part 24 may temporarily classify the plurality of probe vehicles as one of the three types based on the first caution degree of the plurality of probe vehicles. Alternatively, the statistical processing part 24 may temporarily classify the plurality of probe vehicles as one of the four or more types based on the first caution degree of the plurality of probe vehicles.

Furthermore, the statistical processing part 24 may perform the correction of the first caution degree to the second caution degree in Step S6 in accordance with the type of the temporal classification. For example, the statistical processing part 24 may perform the correction of reducing the first caution degree of the first vehicle to obtain the second caution degree when the number of probe vehicles which have been temporarily classified as the semi-caution-needed vehicles in the probe vehicles which have performed the mutual dangerous driving with the first vehicle in the certain period of time is five. In this case, the statistical processing part 24 corrects the first caution degree so that the degree of reducing the first caution degree regarding the mutual dangerous driving with the semi-caution-needed vehicle is smaller than the degree of reducing the first caution degree regarding the mutual dangerous driving with the caution-needed vehicle.

The statistical processing part 24 may classify the plurality of probe vehicles as one of the three or more types based on the second caution degree of the plurality of probe vehicles in the manner similar to the temporal classification described above.

### Modification Example 5 of Embodiment 2

The statistical processing part 24 may obtain a numeral value corresponding to the temporal classification and the classification of the plurality of probe vehicles. For example, the statistical processing part 24 may obtain D(Vn) expressed by the following equation (2) as the numeral value. Then, the statistical processing part 24 may perform the correction of the first caution degree to the second caution degree in Step S6 based on D(Vn).

D(Vn)=first caution degree of vehicle Vn/n (2)

Herein, n indicates the number of encounters in the manner similar to the above equation (1).

### Modification Example 6 of Embodiment 2

The correction of the first caution degree in Step S6 is not limited thereto described above. For example, the statistical processing part 24 may perform processing, in addition to the corrections of (i) and (ii) described in the operation example of the embodiment 2, of (iii) when the number of probe vehicles whose current first caution degree is four score in the probe vehicles which have performed the mutual dangerous driving with the first vehicle in a certain period of time is five, correcting and reducing the first caution degree of the first vehicle by one score to obtain the second caution degree.

That is to say, the statistical processing part 24 may increase the degree of reducing the first caution degree of the first vehicle with increase in the first caution degree of the second vehicle when reducing the first caution degree of the first vehicle.

The second caution degree in this case may be not an integral number.

### Modification Example 7 of Embodiment 2

The correction of the first caution degree in Step S6 is not limited to the correction of reducing the first caution degree described above. For example, when the first caution degree of the second vehicle is equal to or smaller than a threshold value, the statistical processing part 24 may perform the correction of increasing the first caution degree of the first vehicle to obtain the second caution degree. Then, the statistical processing part 24 may increase the degree of increasing the first caution degree of the first vehicle with decrease in the first caution degree of the second vehicle when increasing the first caution degree of the first vehicle. The second caution degree in this case may be not an integral number.

### Embodiment 3

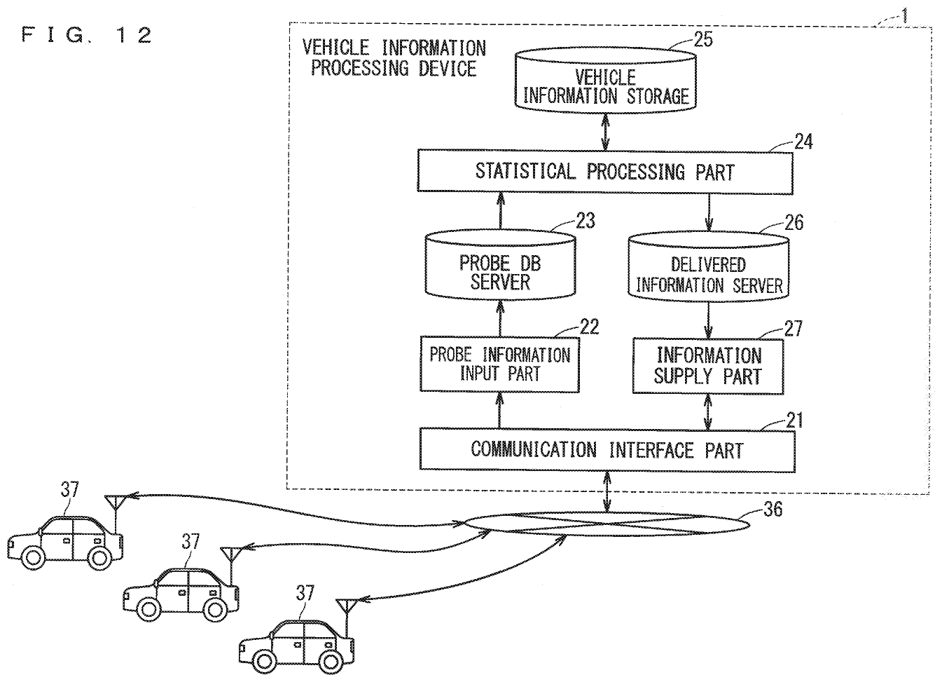

FIG. 12 is a block diagram illustrating a configuration of the vehicle information processing device 1 according to an embodiment 3 of the present invention. The same reference numerals as those described above will be assigned to the same or similar constituent element in the configuration according to the present embodiment 3, and the different constituent elements are mainly described hereinafter.

The vehicle information processing device 1 in FIG. 12 includes a delivered information server 26 and an information supply part 27 in addition to the constituent elements in FIG. 5. The communication interface part 21 and the information supply part 27 are included in a concept of a delivery part.

The communication interface part 21 acquires an information delivery request from an external device located outside the vehicle information processing device 1. The external device located outside the vehicle information processing device 1 is a registered vehicle which is registered in a center server to receive service from the center server, for example.

The statistical processing part 24 generates caution degree information including the second caution degree of at least one of the plurality of probe vehicles 37 as needed. The statistical processing part 24 outputs the generated caution degree information to the delivered information server 26.

The delivered information server 26 stores the caution degree information being output from the statistical processing part 24. When the communication interface part 21 acquires the information delivery request, the information supply part 27 delivers the caution degree information stored in the delivered information server 26 to the outside of the vehicle information processing device 1 via the communication interface part 21.

### Conclusion of Embodiment 3

The vehicle information processing device 1 according to the present embodiment 3 described above delivers the caution degree information to the outside of the vehicle information processing device 1 in accordance with the information delivery request from the outside of the vehicle information processing device 1. According to such a configuration, for example, a user of the registered vehicle can appropriately recognize a magnitude of the second caution degree of the registered vehicle.

### Modification Example 1 of Embodiment 3

The information supply part 27 may deliver the caution degree information to the outside of the vehicle information processing device 1 in accordance with the information delivery request from the outside of the vehicle information processing device 1. The external device located outside the vehicle information processing device 1 is a vehicle registered in a center server to receive service from the center server, for example, and is a specific vehicle receiving less service than the registered vehicle. These vehicles are also referred to as “the delivered vehicle” in some cases in the description hereinafter when the registered vehicle and the specific vehicle are not distinguished from each other.

The statistical processing part 24 may further include, in the caution degree information delivered to the delivered vehicle, a vehicle ID which is sort information enabling the delivered vehicle to sort at least one vehicle other than the delivered vehicle and positional information of the at least one vehicle. According to such a configuration, a display device of the delivered vehicle can perform a display based on the delivered caution degree information.

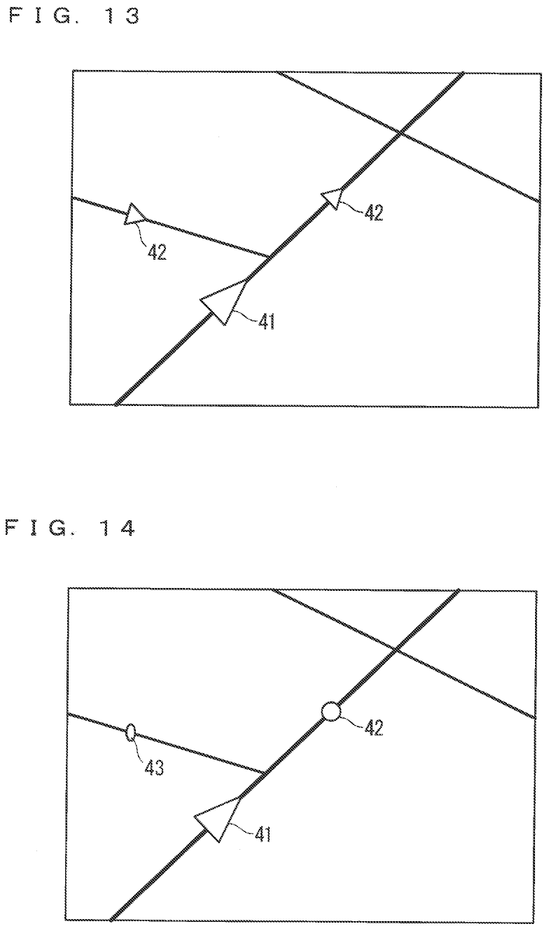

FIG. 13 is a drawing illustrating a display example of the display device in the delivered vehicle. The display example in FIG. 13 illustrates a delivered vehicle 41 and two caution-needed vehicles 42. FIG. 14 is a drawing illustrating another display example of the display device in the delivered vehicle. The display example in FIG. 14 illustrates the delivered vehicle 41, one caution-needed vehicle 42, and one semi-caution-needed vehicle 43. In FIG. 14, a mark of the caution-needed vehicle 42 is made larger than a mark of the semi-caution-needed vehicle 43 so that the mark of the caution-needed vehicle 42 stands out from the mark of the semi-caution-needed vehicle 43. A driver of the delivered vehicle 41 can recognize the vehicle having the high second caution degree in accordance with the display.

When all the second caution degrees are delivered to the vehicle, a delivery load of the vehicle information processing device 1 increases.

Thus, the information supply part 27 may not deliver the caution degree information including the second caution degree smaller than a threshold value.

Alternatively, the information supply part 27 may deliver the caution-needed information of the caution-needed vehicle only when there is a possibility that the normal vehicle encounters the caution-needed vehicle in a predetermined period of time. The predetermined period of time is ten minutes, for example. The possibility of the encounter is obtained by the statistical processing part 24 based on the traveling direction and the speed of each of the plurality of probe vehicles, for example.

Alternatively, it is also applicable that only when the information delivery request includes request source positional information indicating a position of a request source of the information delivery request, the information supply part 27 delivers the caution-needed information of the probe vehicle located in a predetermined range from the position indicated by the request source positional information included in the information delivery request. The predetermined range is a range within 10 km distance from the position indicated by the request source positional information, for example.

The display device of the delivered vehicle may perform the display similar to the delivery described above. Specifically, the display device of the delivered vehicle may not display the position of the probe vehicle having the second caution degree smaller than a threshold value. Alternatively, the display device of the delivered vehicle may display the caution-needed information of the caution-needed vehicle only when there is a possibility that the normal vehicle encounters the caution-needed vehicle in a predetermined period of time. Alternatively, it is also applicable that only when the information delivery request includes request source positional information indicating a position of a request source of the information delivery request, the display device of the delivered vehicle displays the caution-needed information of the probe vehicle located in a predetermined range from the position indicated by the request source positional information included in the information delivery request.

The statistical processing part 24 may change the vehicle ID described above as needed from a viewpoint of an information security. Accordingly, the vehicle ID is not specified beyond necessity, thus the security can be improved.

### Modification Example 2 of Embodiment 3

The vehicle information processing device 1 may acquire attribute information of the plurality of probe vehicles by receiving the information in the communication interface part 21 and input from the other interface. The attribute information of the probe vehicle is information such as a manufacturer, a vehicle rank, a type name, a vehicle specification, a vehicle color, for example, enabling the delivered vehicle or a driver of the delivered vehicle to specify the probe vehicle.

In the configuration described above, the vehicle information storage 25 which is a storage may store the attribute information of the plurality of probe vehicles. The statistical processing part 24 may further include, in the caution degree information delivered to the delivered vehicle, the attribute information of at least one of the vehicles described above in the attribute information stored in the vehicle information storage 25. According to such a configuration, for example, the driver of the delivered vehicle can easily specify the vehicle indicated in the caution degree information.

### Modification Example 3 of Embodiment 3

The vehicle information processing device 1 may acquire a state of dangerous driving in the plurality of probe vehicles by receiving the state in the communication interface part 21 and input from the other interface. The state of dangerous driving is, for example, a sudden interruption of a vehicle, an abrupt steering, a sudden braking, a meandering, and an accidental forgetting to turn on an indication light.

In the configuration described above, the vehicle information storage 25 which is a storage may store the state of the dangerous driving in the plurality of probe vehicles. The statistical processing part 24 may further include, in the caution degree information delivered to the delivered vehicle, the state of dangerous driving of at least one of the vehicles described above in the state of dangerous driving stored in the vehicle information storage 25. According to such a configuration, for example, the driver of the delivered vehicle can recognize what kind of dangerous driving the vehicle indicated in the caution degree information has performed.

### Modification Example 4 of Embodiment 3

The statistical processing part 24 may obtain a collateral degree which is a degree that the first vehicle is involved in the dangerous driving performed by the vehicle other than the first vehicle based on the first caution degree of the first vehicle and the first caution degree of the second vehicle which has performed the mutual dangerous driving with the first vehicle. For example, the statistical processing part 24 increases the collateral degree of the first vehicle when the caution degree of the first vehicle is smaller than a threshold value and a large number of second vehicles have the caution degree equal to or larger than a threshold value in the plurality of second vehicles which have performed the mutual dangerous driving with the first vehicle in a certain period of time. As the collateral degree of a vehicle obtained in the manner described above gets higher, the vehicle tends to be involved in the dangerous driving of the other vehicle by some reason such as a too low speed of the vehicle compared with a legal speed although the vehicle itself does not perform the dangerous driving.

In the configuration described above, the information supply part 27 may deliver the collateral degree of the first vehicle outside the vehicle information processing device. According to such a configuration, for example, the driver of the delivered vehicle can recognize the vehicle which tends to be involved in the dangerous driving.

### Embodiment 4

A block configuration of the vehicle information processing device 1 according to an embodiment 4 of the present invention is the same as the block configuration of the vehicle information processing device 1 according to the embodiment 2 (FIG. 5). The same reference numerals as those described above will be assigned to the same or similar constituent element in the configuration according to the present embodiment 4, and the different constituent elements are mainly described hereinafter.

The statistical processing part 24 according to the present embodiment 4 determines whether each of the plurality of probe vehicles has performed a non-mutual dangerous driving which is a dangerous driving other than the mutual dangerous driving based on the travel information of the plurality of probe vehicles acquired in the communication interface part 21. The non-mutual dangerous driving includes a dangerous driving performed by a sole probe vehicle, for example.

The statistical processing part 24 obtains the caution degree of each of the plurality of probe vehicles also in consideration of the determination result.

<Operation>

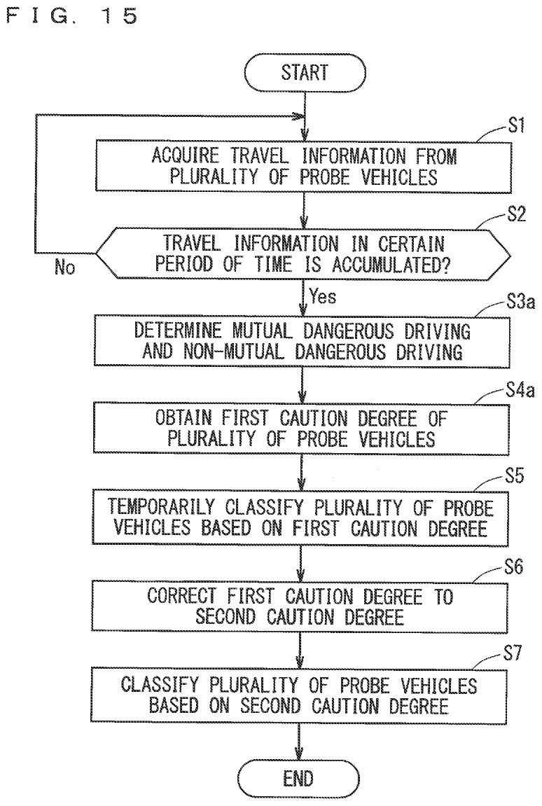

FIG. 15 is a flow chart illustrating an operation of the vehicle information processing device 1 according to the present embodiment 4.

The processing similar to that in Step S1 and Step S2 in FIG. 6 is performed in Step S1 and S2.

In Step S3a, the statistical processing part 24 determines whether the mutual dangerous driving has been performed based on the travel information of the plurality of probe vehicles stored in the probe DB server 23. The statistical processing part 24 determines whether the non-mutual dangerous driving has been performed based on the travel information of the plurality of probe vehicles stored in the probe DB server 23.

In Step S4a, the statistical processing part 24 obtains the first caution degree of each of the plurality of probe vehicles based on the determination result on the mutual dangerous driving and the determination result on the non-mutual dangerous driving. When the mutual dangerous driving and the non-mutual dangerous driving are determined for the same dangerous driving, the statistical processing part 24 reflect only one determination result in the first caution degree so as not to increase the first caution degree redundantly.

Subsequently, the processing similar to that in Steps S5 to S7 in FIG. 6 is performed in Steps S5 to S7.

### Conclusion of Embodiment 4

The vehicle information processing device 1 according to the present embodiment 4 described above obtains the first caution degree of each of the plurality of probe vehicles also in consideration of the determination result whether the non-mutual dangerous driving has been performed. According to such a configuration, the optimization of the first caution degree of each of the plurality of probe vehicles and furthermore, the optimization of the second caution degree can be achieved.

In Step S4a, when the mutual dangerous driving is the dangerous driving performed by the caution-needed vehicles, the statistical processing part 24 may not change the first caution degree of any caution-needed vehicle. The modification example similar to that of the embodiment 2 can also be applied to the present embodiment 4.

### Embodiment 5

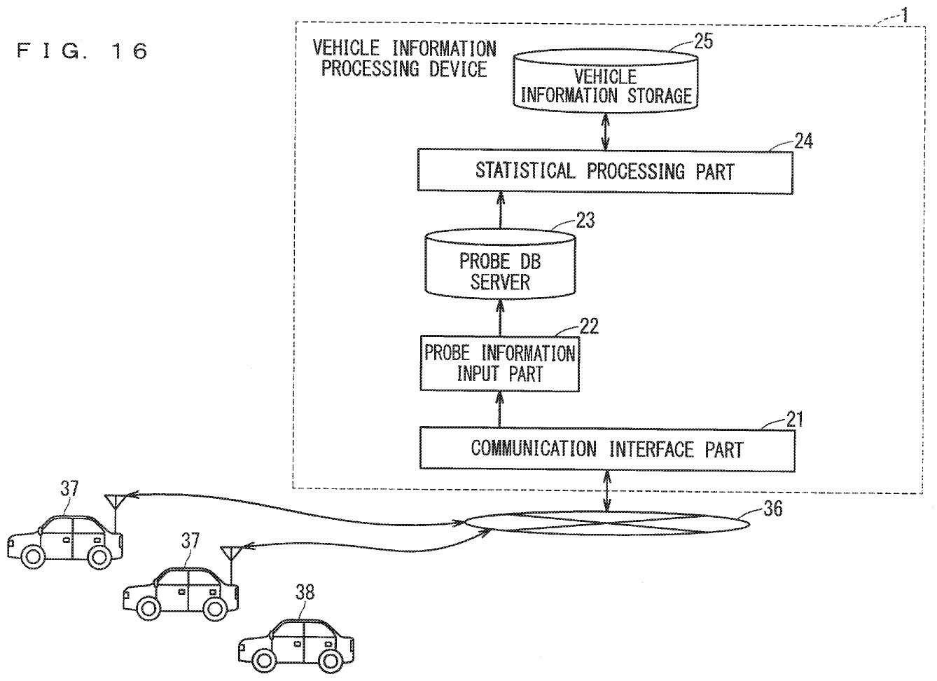

FIG. 16 is a block diagram illustrating a configuration of the vehicle information processing device 1 according to an embodiment 5 of the present invention. The same reference numerals as those described above will be assigned to the same or similar constituent element in the configuration according to the present embodiment 5, and the different constituent elements are mainly described hereinafter.

In the present embodiments 1 to 4, the two or more vehicles performing the mutual dangerous driving are the probe vehicles 37. In the present embodiment 5, the two or more vehicles performing the mutual dangerous driving include the probe vehicle 37 and a probe vehicle 38.

The probe vehicle 37 determines whether the mutual dangerous driving has been performed based on information acquired in the detection device provided in the probe vehicle 37 in the manner similar to the embodiment 2. Then, the probe vehicle 37 transmits the travel information including the determination result on the mutual dangerous driving to the vehicle information processing device 1.

In the present embodiment 5, the probe vehicle 37 determines whether one of the plurality of probe vehicles 37 has performed the other factor dangerous driving which is a dangerous driving caused by a dangerous driving performed by a vehicle other than the one of the plurality of probe vehicles 37 based on the information acquired in the detection device provided in the probe vehicle 37. The vehicle other than the one of the plurality of probe vehicles may be the probe vehicle 37 or the non-probe vehicle 38. Each probe vehicle 37 transmits the determination result on the other factor dangerous driving to the vehicle information processing device 1.

The communication interface part 21 acquires (receives) the travel information of the plurality of probe vehicles 37 and the determination result of the other factor dangerous driving from the plurality of probe vehicles 37 via the communication network 36 such as Internet.

The statistical processing part 24 obtains the first caution degree of the plurality of probe vehicles 37 also in consideration of the determination result of the other factor dangerous driving acquired in the communication interface part 21. For example, when the determination result of the other factor dangerous driving indicates that the dangerous driving has been performed due to the dangerous driving of the non-probe vehicle 38, the statistical processing part 24 does not increase the first caution degree of the probe vehicle 37 which has performed the mutual dangerous driving with the non-probe vehicle 38.

### Conclusion of Embodiment 5

The vehicle information processing device 1 according to the present embodiment 5 described above obtains the first caution degree of each of the plurality of probe vehicles also in consideration of the determination result whether the other factor dangerous driving has been performed. According to such a configuration, the optimization of the first caution degree of each of the plurality of probe vehicles and furthermore, the optimization of the second caution degree can be achieved.

### Modification Example 1 of Embodiment 5

In the embodiment 5, the communication interface part 21 acquires the determination result of the other factor dangerous driving determined in the plurality of probe vehicles, however, the configuration is not limited thereto. For example, determinable information which is information enabling a determination whether one of the plurality of probe vehicles has performed the other factor dangerous driving may be detected by the detection device mounted on each of the plurality of probe vehicles. The determinable information includes sensor information such as time-series information regarding the traveling of the probe vehicle and the non-probe vehicle, positional information of the probe vehicle and the non-probe vehicle, and video information, for example.

In such a configuration, the communication interface part 21 may acquire the determinable information. It is also applicable that the plurality of probe vehicles does not perform the determination of the other factor dangerous driving but the statistical processing part 24 determines whether the other factor dangerous driving has been performed based on the determinable information acquired in the communication interface part 21 to obtain the first caution degree of each of the plurality of probe vehicles 37 also in consideration of the determination result.

### Modification Example 2 of Embodiment 5

According to the configuration of the embodiment 5, there is a case where both the two probe vehicles which have performed the mutual dangerous driving are determined to have performed the other factor dangerous driving. In this case, the statistical processing part 24 is to determine that both the two probe vehicles which have performed the mutual dangerous driving have performed the other factor dangerous driving based on the determination result of the plurality of probe vehicles acquired in the communication interface part 21.

In such a case, the statistical processing part 24 may obtain a responsibility ratio of the two probe vehicles based on the sensor information, for example. As an example thereof, the statistical processing part 24 may make a responsibility ratio of one of the two probe vehicles which has gone over a white line of a road at the time of the mutual dangerous driving higher than a responsibility ratio of the other one of the two probe vehicles which has not gone over the white line of the road at that time. As another example, the statistical processing part 24 may make a responsibility ratio of one of the two probe vehicles which has braked hard earlier at the time of the mutual dangerous driving higher than a responsibility ratio of the other one of the two probe vehicles which has braked hard later at that time,

Then, the statistical processing part 24 may obtain the first caution degree of each of the plurality of probe vehicles also in consideration of the responsibility ratio. For example, when the responsibility ratio of the two probe vehicles is the same as each other, the statistical processing part 24 may increase the first caution degree of the two probe vehicles by 0.5 score for each vehicle, and when the responsibility ratio of the two probe vehicles is 7:3, the statistical processing part 24 may increase the first caution degree of the probe vehicle having a responsibility ratio of 7 by 0.7 score and increase the first caution degree of the probe vehicle having a responsibility ratio of 3 by 0.3 score. According to such a configuration, the optimization of the first caution degree of each of the plurality of probe vehicles and furthermore, the optimization of the second caution degree can be achieved.

### Modification Example of Embodiments 2 to 5

The description in the embodiments 2 to 5 is based on an assumption that an interval of the calculation period of the caution degree is the same in all of the vehicles. However, the calculation interval is not limited thereto, but may be adjusted for each vehicle.

For example, the statistical processing part 24 may obtain the caution degree of each probe vehicle at the time of determination that the dangerous driving has been performed.

It is also applicable that with regard to the probe vehicle whose caution degree is calculated for the first time, the statistical processing part 24 applies an initial value to the caution degree of the probe vehicle until the travel information is accumulated to some degree after a lapse of certain period of time from the probe start, and calculates the caution degree specific to the probe vehicle when the travel information is accumulated to some degree, for example. A statistical value such as an average value and a central value of the caution degrees of the plurality of probe vehicles, for example, may also be applied to the initial value. A statistical value based on information specific to the probe vehicle such as an attribute such as a type of the probe vehicle, a performance and type of a safety device mounted on the probe vehicle, a hub area of the probe vehicle, a purpose of use of the probe vehicle (for example, a professional use) may also be applied to the initial value. A statistical value based on information specific to a driver such as an attribute, an age, a driving record, a driving accident record, and a discount rate of automobile insurance of a driver who drives the probe vehicle may also be applied to the initial value.

### Another Modification Example

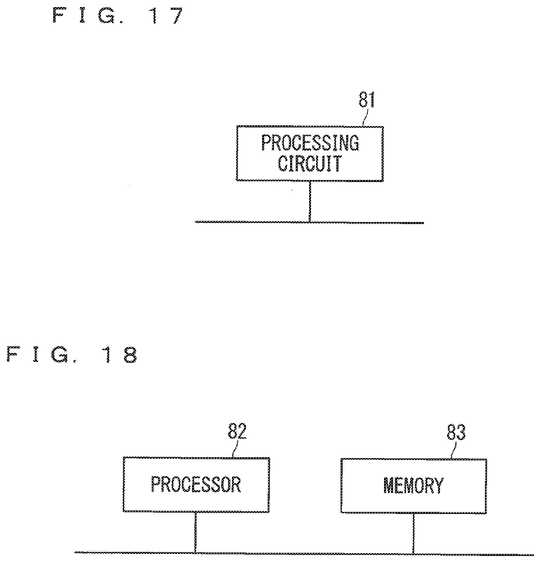

The acquisition part 11 and the controller 12 in FIG. 1 described above are referred to as “the acquisition part 11 etc.” hereinafter. The acquisition part 11 etc. is achieved by a processing circuit 81 illustrated in FIG. 17. That is to say, the processing circuit 81 includes the acquisition part 11 acquiring the travel information of the plurality of vehicles and the controller 12 determining whether the mutual dangerous driving which is the dangerous driving mutually related between two or more vehicles in the plurality of vehicles has been performed based on the travel information of the plurality of vehicles acquired in the acquisition part 11, obtaining the caution degree which is a degree of caution to be exerted in each of the plurality of vehicles based on the determination result, and performing the control of correcting the caution degree of the first vehicle in the plurality of vehicles based on the caution degree of the second vehicle in the plurality of vehicles which has performed the mutual dangerous driving with the first vehicle. Dedicated hardware may be applied to the processing circuit 81, or a processer executing a program stored in a memory may also be applied. Examples of the processor include a central processing unit, a processing device, an arithmetic device, a microprocessor, a microcomputer, or a digital signal processor (DSP).

When the processing circuit 81 is the dedicated hardware, a single circuit, a complex circuit, a programmed processor, a parallel-programmed processor, an application specific integrated circuit (ASIC), a field-programmable gate array (FPGA), or a combination of them, for example, falls under the processing circuit 81. Each function of the acquisition part 11 etc. may be achieved by circuits to which the processing circuit is dispersed, or each function of them may also be collectively achieved by one processing circuit.

When the processing circuit 81 is the processor, the functions of the acquisition part 11 etc. are achieved by a combination with software etc. Software, firmware, or software and firmware, for example, fall under the software etc. The software etc. is described as a program and is stored in a memory 83. As illustrated in FIG. 18, a processor 82 applied to the processing circuit 81 reads out and executes a program stored in the memory 83, thereby achieving the function of each unit. That is to say, the vehicle information processing device 1 includes the memory 83 to store the program to resultingly execute, at a time of being executed by the processing circuit 81, steps of: acquiring the travel information of the plurality of vehicles; determining whether the mutual dangerous driving which is the dangerous driving mutually related between two or more vehicles in the plurality of vehicles has been performed based on the travel information of the plurality of vehicles which has been acquired and obtaining the caution degree which is a degree of caution to be exerted in each of the plurality of probe vehicles based on the determination result; and performing the control of correcting the caution degree of the first vehicle based on the caution degree of the second vehicle, in the plurality of vehicles, which has performed the mutual dangerous driving with the first vehicle in the plurality of vehicles. In other words, this program is also deemed to make a computer execute a procedure or a method of the acquisition part 11 etc. Herein, the memory 83 may be a non-volatile or volatile semiconductor memory such as a RAM (Random Access Memory), a ROM (Read Only Memory), a flash memory, an EPROM (Electrically Programmable Read Only Memory), or an EEPROM (Electrically Erasable Programmable Read Only Memory), an HDD (Hard Disk Drive), a magnetic disc, a flexible disc, an optical disc, a compact disc, a mini disc, a DVD (Digital Versatile Disc), or a drive device of them, or any storage medium which is to be used in the future.

Described above is the configuration that each function of the acquisition part 11 etc. is achieved by one of the hardware and the software, for example. However, the configuration is not limited thereto, but also applicable is a configuration of achieving a part of the acquisition part 11 etc. by dedicated hardware and achieving another part of them by software, for example. For example, the function of the acquisition part 11 can be achieved by the processing circuit 81 as the dedicated hardware and a receiver, for example, and the function of the other units can be achieved by the processing circuit 81 as the processor 82 reading out and executing the program stored in the memory 83.

As described above, the processing circuit 81 can achieve each function described above by the hardware, the software, or the combination of them, for example.

The vehicle information processing device 1 described above can also be applied to a vehicle information processing system constructed as a system by appropriately combining a navigation device such as a Portable Navigation Device (PND), a communication terminal including a portable terminal such as a mobile phone, a smartphone, or a tablet, for example, a function of an application installed on at least one of the navigation device and the communication terminal, and a server, for example. In this case, each function or each constituent element of the vehicle information processing device 1 described above may be dispersedly disposed in each apparatus constructing the system, or may also be collectively disposed in one of the apparatuses.

According to the present invention, each embodiment can be arbitrarily combined, or each embodiment can be appropriately varied or omitted within the scope of the invention.

Although the present invention is described in detail, the foregoing description is in all aspects illustrative and does not restrict the invention. It is therefore understood that numerous modifications and variations can be devised without departing from the scope of the invention.

### EXPLANATION OF REFERENCE SIGNS

1 vehicle information processing device, 11 acquisition part, 12 controller, 21 communication interface part, 27 information supply part, 25 vehicle information storage, 37 probe vehicle, 38 non-probe vehicle.

1. A vehicle information processing apparatus, comprising:
a receiver acquiring travel information of a plurality of vehicles; and
a controller determining whether a mutual dangerous driving which is a dangerous driving mutually related between two or more vehicles in the plurality of vehicles has been performed based on the travel information of the plurality of vehicles acquired in the receiver, and obtaining a caution degree which is a degree of caution to be exerted in each vehicle in the plurality of vehicles and indicates a possibility of incurring a dangerous driving from the vehicle in a case of encountering the vehicle based on a determination result, wherein
the controller performs control of correcting the caution degree of a first vehicle in the plurality of vehicles based on the caution degree of a second vehicle in the plurality of vehicles which has performed the mutual dangerous driving with the first vehicle.

2. The vehicle information processing apparatus according to claim 1, wherein
the controller determines whether each of the plurality of vehicles has performed a non-mutual dangerous driving which is a dangerous driving other than the mutual dangerous driving based on the travel information of the plurality of vehicles acquired in the receiver, and obtains the caution degree of each of the plurality of vehicles also in consideration of a determination result.

3. The vehicle information processing apparatus according to claim 1, wherein
the travel information of the plurality of vehicles includes a determination result whether the mutual dangerous driving has been performed.

4. The vehicle information processing apparatus according to claim 1, wherein
the travel information of the plurality of vehicles includes time-series information regarding a traveling of the plurality of vehicles and positional information of the plurality of vehicles.

5. The vehicle information processing apparatus according to claim 1, wherein
the receiver further acquires the time-series information regarding the traveling of the plurality of vehicles, and
the controller obtains a degree of a dangerous driving of the plurality of vehicles based on the time-series information of the plurality of vehicles acquired in the receiver, and obtains the caution degree of the plurality of vehicles also in consideration of the degree of the dangerous driving.

6. The vehicle information processing apparatus according to claim 1, wherein
the controller classifies the plurality of vehicles based on the caution degree, which has been corrected, of each of the plurality of vehicles.

7 A vehicle information processing apparatus, comprising:
a receiver acquiring travel information of a plurality of vehicles; and
a controller determining whether a mutual dangerous driving which is a dangerous driving mutually related between two or more vehicles in the plurality of vehicles has been performed based on the travel information of the plurality of vehicles acquired in the receiver, and obtaining a caution degree which is a degree of caution to be exerted in each of the plurality of vehicles based on a determination result, wherein
the controller performs control of correcting the caution degree of a first vehicle in the plurality of vehicles based on the caution degree of a second vehicle in the plurality of vehicles which has performed the mutual dangerous driving with the first vehicle, and
the controller reduces the caution degree of the first vehicle when the caution degree of the second vehicle is equal to or larger than a threshold value, or
increases the caution degree of the first vehicle when the caution degree of the second vehicle is equal to or smaller than a threshold value.

8. The vehicle information processing apparatus according to claim 7, wherein
the controller increase a degree of reducing the caution degree of the first vehicle with increase in the caution degree of the second vehicle when reducing the caution degree of the first vehicle, and
the controller increase a degree of increasing the caution degree of the first vehicle with decrease in the caution degree of the second vehicle when increasing the caution degree of the first vehicle.

9. The vehicle information processing apparatus according to claim 1, wherein
the receiver further acquires an information delivery request from outside of the vehicle information processing apparatus, and
the vehicle information processing apparatus further includes a delivery part delivering, to outside the vehicle information processing apparatus, caution degree information including the caution degree, which has been corrected, of at least one of the plurality of vehicles when the receiver acquires the information delivery request.

10. The vehicle information processing apparatus according to claim 9, wherein
the caution degree information further includes sort information enabling a vehicle other than the at least one of the plurality of vehicles to sort the at least one of the plurality of vehicles and positional information of the at least one of the plurality of vehicles.

11. The vehicle information processing apparatus according to claim 10, wherein
the vehicle information processing apparatus changes the sort information as needed.

12. The vehicle information processing apparatus according to claim 10, wherein
the delivery part delivers the caution degree information of a caution-needed vehicle, which is a vehicle having the caution degree which has been corrected equal to or larger than a threshold value in the plurality of vehicles, when there is a possibility that a normal vehicle, which is a vehicle having the caution degree which has been corrected smaller than the threshold value in the plurality of vehicles, encounters the caution-needed vehicle in a predetermined period of time.

13. The vehicle information processing apparatus according to claim 10, wherein
the information delivery request includes request source positional information indicating a position of a request source of the information delivery request, and
the delivery part delivers the caution degree information of a vehicle in the plurality of vehicles located in a predetermined range from the position indicated by the request source positional information included in the information delivery request.

14. The vehicle information processing apparatus according to claim 10, further comprising
a storage storing attribute information of the plurality of vehicles, wherein
the caution degree information further includes attribute information of the at least one of the plurality of vehicles in the attribute information stored in the storage.

15. The vehicle information processing apparatus according to claim 10, further comprising
a storage storing a state of dangerous driving in the plurality of vehicles, wherein
the caution degree information further includes a state of dangerous driving of the at least one of the plurality of vehicles in the state of dangerous driving stored in the storage.

16. The vehicle information processing apparatus according to claim 1, wherein
the receiver further acquires a determination result whether one of the plurality of vehicles has performed another factor dangerous driving which is a dangerous driving caused by a dangerous driving performed by a vehicle other than the one of the plurality of vehicles, and
the controller obtains the caution degree of each of the plurality of vehicles also in consideration of the determination result acquired in the receiver.

17. The vehicle information processing apparatus according to claim 1, wherein
the receiver further acquires determinable information which is information enabling a determination whether one of the plurality of vehicles has performed the another factor dangerous driving which is a dangerous driving caused by a dangerous driving performed by a vehicle other than the one of the plurality of vehicles, and
the controller determines whether the another factor dangerous driving has been performed based on the determinable information acquired in the receiver, and obtains the caution degree of each of the plurality of vehicles also in consideration of the determination result.

18. The vehicle information processing apparatus according to claim 16, wherein
the controller obtains a responsibility ratio of two vehicles which have performed the mutual dangerous driving when determining that both the two vehicles have performed the another factor dangerous driving based on the determination result of the plurality of vehicles acquired in the receiver, and obtains the caution degree of each of the plurality of vehicles also in consideration of the responsibility ratio.

19. The vehicle information processing apparatus according to claim 1, wherein
the controller obtains a collateral degree which is a degree that the first vehicle is involved in a dangerous driving performed by a vehicle other than the first vehicle based on the caution degree of the first vehicle and the caution degree of the second vehicle, and
the vehicle information processing apparatus further includes a delivery part delivering the collateral degree of the first vehicle to outside the vehicle information processing apparatus.

20. A vehicle information processing method, comprising:
acquiring travel information of a plurality of vehicles;
determining whether a mutual dangerous driving which is a dangerous driving mutually related between two or more vehicles in the plurality of vehicles has been performed based on the travel information of the plurality of vehicles which has been acquired, and obtaining a caution degree which is a degree of caution to be exerted in each vehicle in the plurality of vehicles and indicates a possibility of incurring a dangerous driving from the vehicle in a case of encountering the vehicle based on a determination result; and
performing control of correcting the caution degree of a first vehicle in the plurality of vehicles based on the caution degree of a second vehicle in the plurality of vehicles which has performed the mutual dangerous driving with the first vehicle.
